(19) United States
(12) Patent Application Publication
(10) Pub. No.: US 2025/0168959 A1
(43) Pub. Date: May 22, 2025

(54) LAMP EFFECT CONTROL METHOD, DEVICE, APPARATUS AND MEDIUM

(71) Applicant: SHENZHEN HYSIRY TECHNOLOGY CO., LTD., SHENZHEN (CN)

(72) Inventor: MING LI, SHULAN (CN)

(21) Appl. No.: 18/408,768

(22) Filed: Jan. 10, 2024

(30) Foreign Application Priority Data
Nov. 22, 2023 (CN) 202311561322.9

(51) Int. Cl. H05B 47/175

(52) U.S. Cl. CPC H05B 47/1985

(57) ABSTRACT

Disclosed is a lamp effect control method, and the method includes: obtaining a lamp effect scheme through control software design, converting the lamp effect scheme into a control instruction, and sending the control instruction to a control terminal; receiving the control instruction through the control terminal and sending the control instruction to controller firmware; receiving the control instruction through the controller firmware, converting the control instruction into a control signal, and sending the control signal to a string lamp; and receiving the control signal through the string lamp and implementing the lamp effect scheme according to the control signal. The lamp effect control method simplifies the process of lamp effect development, reduces the lamp effect development thresholds, improves development efficiency, and enhances the diversity of lamp effects.

### TECHNICAL FIELD

The present disclosure relates to the technical field of lamp effect control and communication, and particularly relates to a lamp effect control method, device, apparatus and medium.

### BACKGROUND

A string lamp is a decorative lamp that connects a plurality of point-controlled lamp beads through a serial or parallel circuit. As a decorative element, the string lamp is commonly used in various scenes such as festival celebrations, indoor and outdoor decorations, etc., and is deemed as one of the most widely used atmosphere creating decorations. The string lamp can be controlled simply by using a physical switch, and lamp effect control can also be achieved in a wired or wireless manner. Wired connections, such as USB interfaces and serial ports, are capable to achieve stable and reliable signal transmission, but there exist certain limitations. Common wireless connection technologies, including Bluetooth, Wi-Fi, infrared rays and 2.4G, allow users, by using smart mobile terminals such as remote controllers or mobile Apps, to remotely control the lamp effect and achieve switching on/off, brightness adjustment, color change, mode adjustment, etc. Compared to wired connections, wireless connections have the advantages of high flexibility, easy operation, remote control and the like.

Traditionally, familiarity with knowledge about programming and hardware drivers is required for designing and controlling the string lamp effect, and only developers with certain programming knowledge or expertise can engage in customized development. The lamp effect is read by the controller and transmitted to the string lamp for playback, and the controller needs to be reprogrammed to change the lamp effect, resulting in that operations are cumbersome and development thresholds are high. In recent years, lamp effect control technology has been gradually improved, but a vast majority of lamp effect control products are still limited to preset fixed modes and colors, or a combination of the same. As a result, the users can only choose preset lamp effects and cannot make personalized adjustments according to their needs, so that their requirements for diverse lamp effects cannot be satisfied.

### SUMMARY

Based on the above application requirements and technical background, in order to solve the technical problems in the prior art such as high thresholds and insufficient diversity in the development of lamp effects, the present disclosure adopts the following technical solution:

in a first aspect, the present disclosure provides a lamp effect control method, and the method includes the following steps:

obtaining a lamp effect scheme through control software design, converting the lamp effect scheme into a control instruction, and sending the control instruction to a control terminal;

receiving the control instruction through the control terminal and sending the control instruction to controller firmware; and

receiving the control instruction through the controller firmware, converting the control instruction into a control signal, and sending the control signal to a string lamp; receiving the control signal through the string lamp and implementing the lamp effect scheme according to the control signal.

Further, the step of “obtaining a lamp effect scheme through control software design” further includes:
creating a lamp effect through a lamp effect creating unit and setting the total number of point-controlled lamp beads of the string lamp;
creating an area through an area creating unit;
dividing the point-controlled lamp beads of the string lamp by areas through an area editing unit;
editing an area lamp effect through a lamp effect editing unit, where the types of the area lamp effect include a single image, an animation and a preset, and selecting a type of area lamp effect for lamp effect editing; and
saving the area lamp effect through the area creating unit, and after all the areas are created and saved, saving the lamp effects through the lamp effect creating unit to obtain a lamp effect scheme.

Further, when it is applied to a lattice-shaped string lamp, the step of “obtaining a lamp effect scheme through control software design” further includes:
creating a lamp effect through a lamp effect creating unit and setting the number of strings of point-controlled lamp beads of the string lamp and the total number of point-controlled lamp beads of a single string;
editing a lamp effect through a lamp effect editing unit, where the types of the lamp effect include a single image, an animation and a preset, and selecting a type of lamp effect for lamp effect editing; and
saving the lamp effects through the lamp effect creating unit to obtain a lamp effect scheme.

Further, the control software includes a lamp effect sharing module, and through the lamp effect sharing module, the obtained lamp effect scheme is uploaded online for other users of the control software to download and use.

Further, after selecting a single image according to the step of selecting a type of area lamp effect for lamp effect editing, the following area lamp effects are available, including forward movement, reverse movement, cyclic forward movement, cyclic reverse movement, breathing, flickering and being static, further including the change speed, brightness and color.

Further, after selecting an animation according to the step of selecting a type of area lamp effect for lamp effect editing, the following area lamp effects are available, including flickering, breathing and jumping, further including frame creating, where each frame created through the frame creating includes information of the change speed, brightness and color.

Further, after selecting a preset according to the step of selecting a type of area lamp effect for lamp effect editing, the following area lamp effects are available, including various lamp effects preset through the control software, which can be selected by clicking on the lamp effect number, further including the change speed and brightness.

In a second aspect, the present disclosure provides a lamp effect control device, and the device includes a control terminal, control software, controller firmware and a string lamp, where
the control software is installed and run on the control terminal, including a lamp effect editing module and a data processing module, where the lamp effect editing module is configured to design and obtain a lamp effect scheme and send the lamp effect scheme to the data processing module, and the data processing module is configured to convert the received lamp effect scheme into a control instruction and send the control instruction to the control terminal;
the control terminal includes a first communication module configured to receive the control instruction and send the control instruction to the controller firmware;
the controller firmware is in fit with the control terminal and the control software, including a second communication module, a control module and a drive module, where the second communication module is configured to receive the control instruction, the control module is configured to convert the control instruction into a control signal, and the drive module is configured to send the control signal to the string lamp; and
the string lamp is an addressable string lamp that is in fit with the controller firmware, and the string lamp includes a plurality of point-controlled lamp beads, receives the control signal, and implements the lamp effect scheme through the point-controlled lamp beads.

In a third aspect, the present disclosure provides an electronic apparatus, and the apparatus includes a processor and a memory, where a computer program is stored on the memory, and the processor is configured to implement the above lamp effect control method when executing the computer program.

In a fourth aspect, the present disclosure provides a computer-readable storage medium, and the medium includes a stored computer program, where when the computer program is executed, the device where the computer-readable storage medium is located is controlled to implement the above lamp effect control method.

Compared with the prior art, the present disclosure has the following beneficial effects:

The lamp effect control method provided in the present disclosure simplifies the process of lamp effect development, allowing a user to independently design the lamp effect through the control software on the control terminal without need to pay attention to underlying codes and hardware drivers. In combination with the controller firmware, the method is applicable to almost all types of string lamp products, so that the designed lamp effect can be achieved. The method is simple and easy to implement, reduces the lamp effect development thresholds, improves development efficiency, and enhances the diversity of lamp effects. Further, the lamp effect control device, apparatus and medium disclosed in the present disclosure also have the above beneficial effects.

### BRIEF DESCRIPTION OF THE DRAWINGS

In order to more clearly describe the technical solutions in the embodiments of the present disclosure or in the prior art, a brief introduction to the accompanying drawings required for the description of the embodiments or the prior art will be made below. Apparently, the accompanying drawings in the following description are merely some embodiments of the present disclosure, and those of ordinary skill in the art would also be able to derive other drawings from these drawings without making creative efforts.

FIG. 1 is a flowchart of a lamp effect control method provided in the present disclosure.

FIG. 2 is a flowchart of a lamp effect scheme obtained through a lamp effect control method provided in the present disclosure.

FIG. 3 is a schematic diagram of an interface of a lamp effect creating unit according to a lamp effect control method provided in the present disclosure.

FIG. 4 is a schematic diagram of an interface of setting the total number of point-controlled lamp beads according to a lamp effect control method provided in the present disclosure.

FIG. 5 is a schematic diagram of an interface of an area creating unit according to a lamp effect control method provided in the present disclosure.

FIG. 6 is a schematic diagram of a relationship between a lamp effect and an area according to a lamp effect control method provided in the present disclosure.

FIG. 7 is a schematic diagram of dividing point-controlled lamp beads by areas through an area editing unit according to a lamp effect control method provided in the present disclosure.

FIG. 8 is a schematic diagram of an interface of editing a lamp effect of a single image type according to a lamp effect control method provided in the present disclosure.

FIG. 9 is a schematic diagram of another interface of editing a lamp effect of a single image type according to a lamp effect control method provided in the present disclosure.

FIG. 10 is a schematic diagram of an interface of editing a lamp effect of an animation type according to a lamp effect control method provided in the present disclosure.

FIG. 11 is a schematic diagram of another interface of editing a lamp effect of an animation type according to a lamp effect control method provided in the present disclosure.

FIG. 12 is a schematic diagram of an interface of creating a preset type mode according to a lamp effect control method provided in the present disclosure.

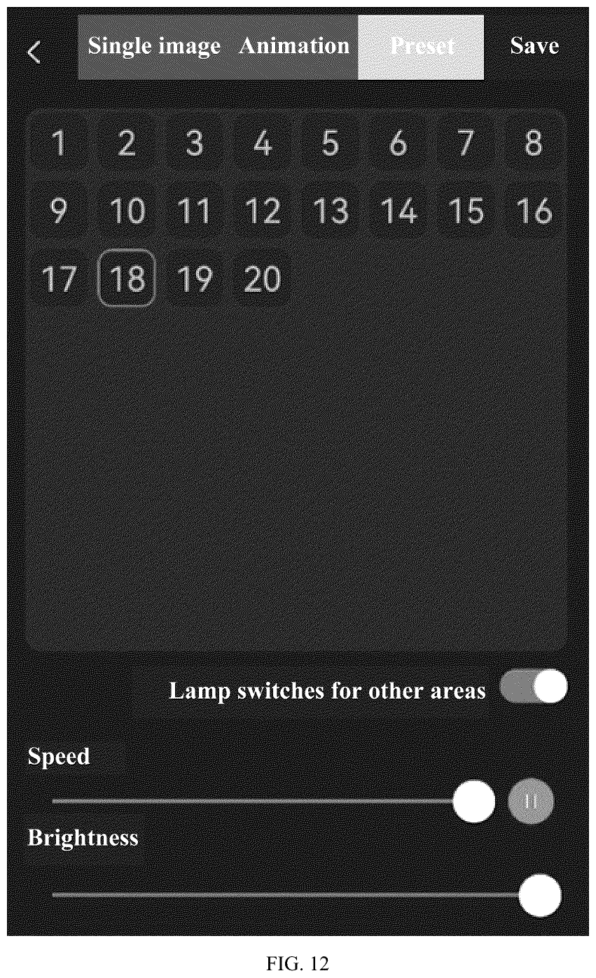

FIG. 13 is a schematic diagram of an interface of obtaining a lamp effect number after uploading a lamp effect scheme according to a lamp effect control method provided in the present disclosure.

FIG. 14 is a schematic diagram of an interface of an I/O configuration page according to a lamp effect control method provided in the present disclosure.

FIG. 15 is a schematic diagram of an interface of setting an IO parameter in detail according to a lamp effect control method provided in the present disclosure.

FIG. 16 is a schematic diagram of an interface of setting the number of point-controlled lamp beads applied to a lattice-shaped string lamp according to a lamp effect control method provided in the present disclosure.

FIG. 17 is a schematic diagram of a rectangular canvas interface applied to a lattice-shaped string lamp according to a lamp effect control method provided in the present disclosure.

### DETAILED DESCRIPTIONS OF THE EMBODIMENTS

The present disclosure provides a lamp effect control method, device, apparatus and medium. In order to illustrate the present disclosure in a more specific manner, the technical solution of the present disclosure will be described in detail below in conjunction with the accompanying drawings and specific embodiments. It should be understood that the particular embodiments described herein are merely illustrative of the present disclosure and are not intended to limit the present disclosure. On the basis of the embodiments of the present disclosure, all other embodiments obtained by those of ordinary skill in the art without making creative efforts fall within the scope of protection of the present disclosure.

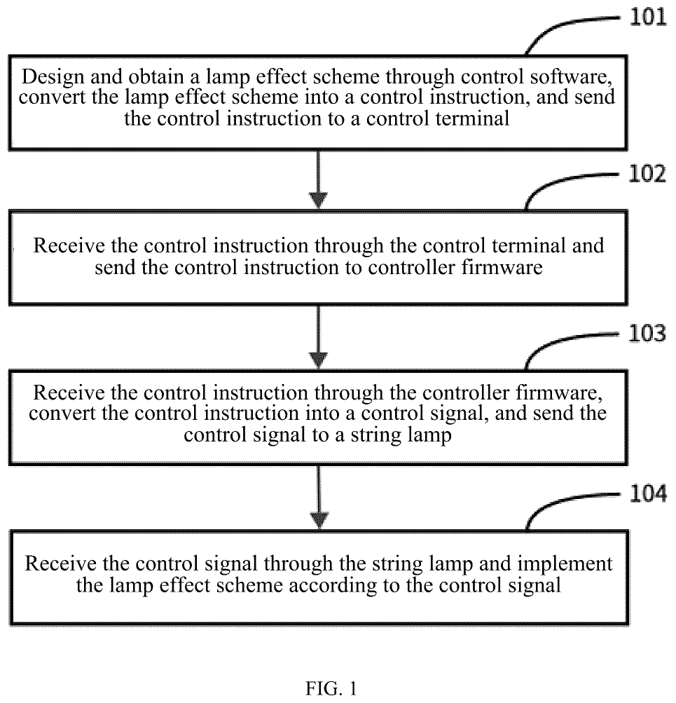

In a first aspect, the present disclosure provides a lamp effect control method, and a flowchart of the lamp effect control method is shown in FIG. 1, with specific steps as follows:

S101, the control software is installed and run on a control terminal, including a lamp effect editing module and a data processing module, where the lamp effect editing module is configured to design and obtain a lamp effect scheme and send the lamp effect scheme to the data processing module, and the data processing module is configured to convert the received lamp effect scheme into a control instruction and send the control instruction to the control terminal; and

Optionally, the control software may further include: a user management module, configured to manage the authority and account information of end users; a data storage module, configured to store and manage lamp effect schemes designed by users and related data; a scenario mode module, configured to automatically switch lamp effect schemes according to user-defined different scenarios or specific conditions, for example, the lamp effects may be changed with movements and actions of mobile phones (such as shaking, rotating, etc.), or according to the time and weather information displayed on the mobile phones; and an expansion interface module, configured to develop and integrate other functional modules to achieve richer lamp effect control functions, for example, the lamp effects may be changed based on the intensity, frequency and rhythm of environmental sounds such as music.

Optionally, the user can convert an image into a lamp effect scheme. After importing an image, the control software will use an image processing algorithm to extract feature information of contours and edges in the imported image, then divide the image into different areas for application to area division of a string lamp, and fill in the areas by use of colors extracted from the image, to help the user quickly and automatically generate a lamp effect scheme based on the image. Afterwards, the user can continue to make adjustments and optimizations, which not only saves the user's time and energy, but also improves efficiency and accuracy. Optionally, the user can also convert videos into lamp effects.

S102, the control terminal includes a first communication module configured to receive the control instruction and send the control instruction to controller firmware; and

Optionally, the control terminal can be a smartphone, a tablet PC, a Personal Digital Assistant (PDA), a laptop or a mobile smart device that is capable to independently complete communication and computation. In an embodiment, a smartphone as the control terminal is configured with an Android or iOS platform, and the control software is a mobile App.

Optionally, the first communication module can be a Bluetooth module, a Wi-Fi module, a Zigbee module or a LoRa module, etc. In an embodiment, the first communication module is a Bluetooth low energy (BLE) chip that achieves data communication based on the BLE specification.

Optionally, the control terminal, through the first communication module, is also capable to receive control instructions from other devices including external devices such as sensors, and these instructions can also be parsed and executed through the controller firmware. In this way, the control terminal can be linked and controlled together with other devices to achieve interaction and coordinated operation between the devices.

S103, the controller firmware is in fit with the control terminal and the control software, including a second communication module, a control module and a drive module, where the second communication module is configured to receive the control instruction, the control module is configured to convert the control instruction into a control signal, and the drive module is configured to send the control signal to the string lamp; and

the control software can be connected to the controller firmware through the first Bluetooth module and the second Bluetooth module, after connection, data communication between the control software and the controller firmware is achieved, and then after a custom data instruction protocol is adopted, the control software, through the control terminal, sends the control instruction to the controller firmware.

Optionally, in addition to basic communication functions, the second communication module is also capable to control the operation of the drive module and use the computing function of a processor in the Bluetooth module to complete the basic operations required for controlling the drive module, thereby saving the cost and reducing the complexity and weight of the entire system.

Optionally, the controller firmware can further include: a status monitoring module, configured to monitor the status of the string lamp and report the status to the control terminal and the control software, so as to understand the operating status of the string lamp in real time; and a power management module, configured to manage the power supply for the string lamp.

S104, the string lamp is an addressable string lamp that is in fit with the controller firmware, and the string lamp includes a plurality of point-controlled lamp beads, receives the control signal, and implements the lamp effect scheme through the point-controlled lamp beads.

The string lamp programs the controller firmware, and the string lamp refers to a single linear string lamp or a lattice-shaped string lamp that combines and connects point-controlled lamp beads of varying numbers that form a certain shape. The single linear string lamp is composed of a single linear string of lamp beards, and such string lamps include those of cloth painting series, rainbow film series and ornament series; and the lattice-shaped string lamps include tree lamps, curtain lamps, ball lamps, waterfall lamps, ice strip lamps, and various special-shaped lamps.

Area division of the single linear string lamp is performed based on the lamp string shape and the distribution of lamp beads, corresponding lamp effects are set according to the characteristics of each area, and finally the lamp effects of a plurality of areas are combined to obtain a lamp effect scheme; and for the lattice-shaped string lamp, the numbers of rows and columns of the lattice are set based on the shape of the lattice, so that users can visually design lamp effects, thus reducing the difficulty of lamp effect design.

All the point-controlled lamp beads of the addressable string lamp can be individually controlled, and can be controlled to display different colors and states at the same time, to jointly form a colorful lamp effect. The point-controlled lamp beads include point-controlled lamp beads with/without address codes, and each lamp bead with the address code has a unique address code that will not change due to any change in its position in the string; and the address of a point-controlled lamp bead without the address code is determined according to its position in the string, for example, the address of the first lamp bead in a certain direction of the string can be set to 0, the address of the second lamp bead can be set to 1, and so on.

When the string lamp is a single linear string lamp, the point-controlled lamp beads can be either point-controlled lamp beads with address codes or point-controlled lamp beads without address codes, both of which can be addressable; and when the string lamp is a lattice-shaped string lamp, the point-controlled lamp beads must be point-controlled lamp beads with address codes or point-controlled lamp beads without address codes that are assigned with fixed addresses through an address allocator.

Optionally, the user not only can preview a lamp effect through a canvas of the control software, but also can view a lamp effect of the string lamp through the control software in real time. It should be noted that because actual light colors of point-controlled lamp beads are different from the colors displayed on a mobile phone screen, the colors displayed in the control software may be different from the actual light colors of the point-controlled lamp beads. Due to network factors, the process of viewing in real time may be delayed.

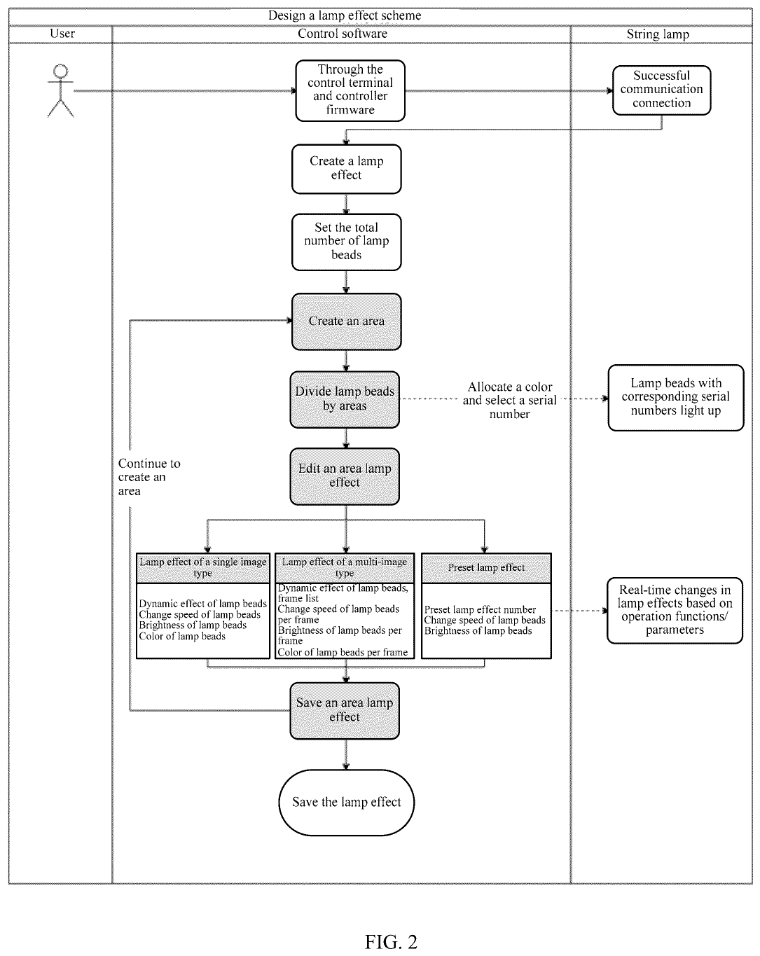

In an embodiment, the process of obtaining a lamp effect scheme through the lamp effect editing module is shown in FIG. 2, including:

S201, creating a lamp effect through a lamp effect creating unit and setting the total number of point-controlled lamp beads;

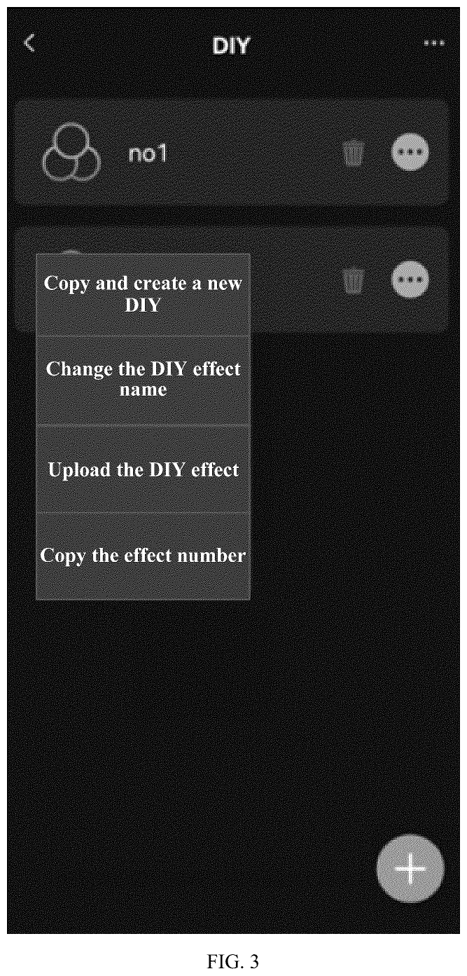

An interface of the lamp effect creating unit is shown in FIG. 3. After creating a lamp effect, the user can edit, delete, select, copy, name, rename the lamp effect, etc. Optionally, the user can copy the lamp effect to create another identical lamp effect, and may edit the identical lamp effect.

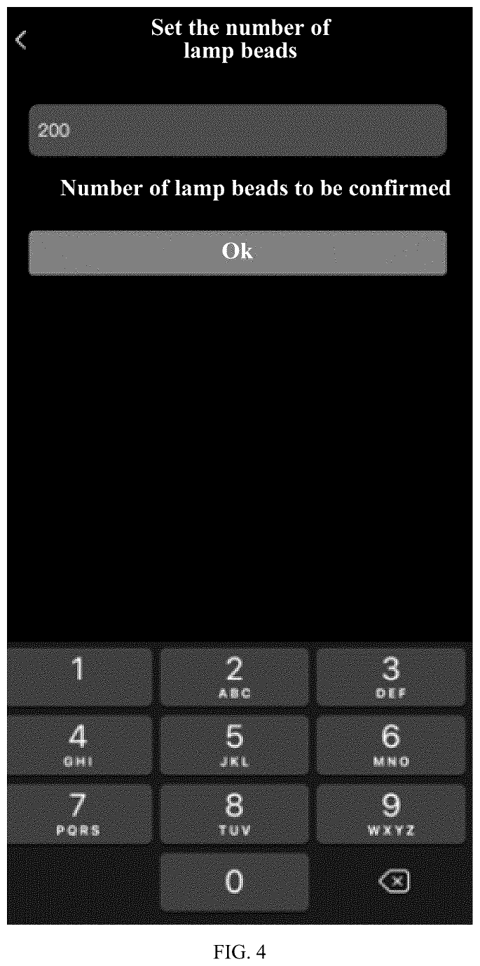

An interface of setting the total number of point-controlled lamp beads through the lamp effect creating unit is shown in FIG. 4. The total number of point-controlled lamp beads is set to avoid errors caused by inconsistency between the actual number of point-controlled lamp beads and the number of the same indicated in the lamp effect scheme. After creating a lamp effect, the user first needs to set the total number of point-controlled lamp beads of the string lamp, or choose the default maximum number of point-controlled lamp beads.

S202, creating an area through an area creating unit;

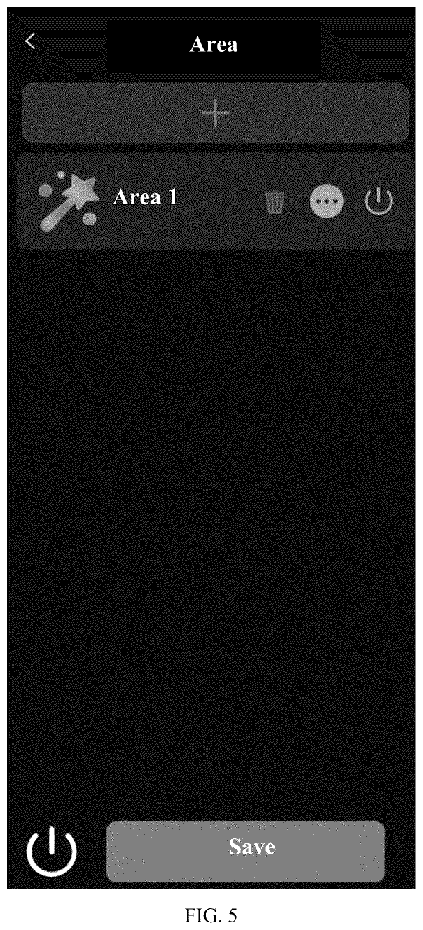

An interface of the area creating unit is shown in FIG. 5. After creating an area, the user can save, edit, delete, select, name, rename the area, set an identification image therefor, etc. After creating an area, the user can name and set an identification image to distinguish the area. The maximum number of areas depends on the controller firmware, and at least 20 areas can be created. When creating areas, the user needs to pay attention to the limit of areas by the controller firmware and make reasonable planning and setting according to needs.

S203, dividing the point-controlled lamp beads by areas through an area editing unit;

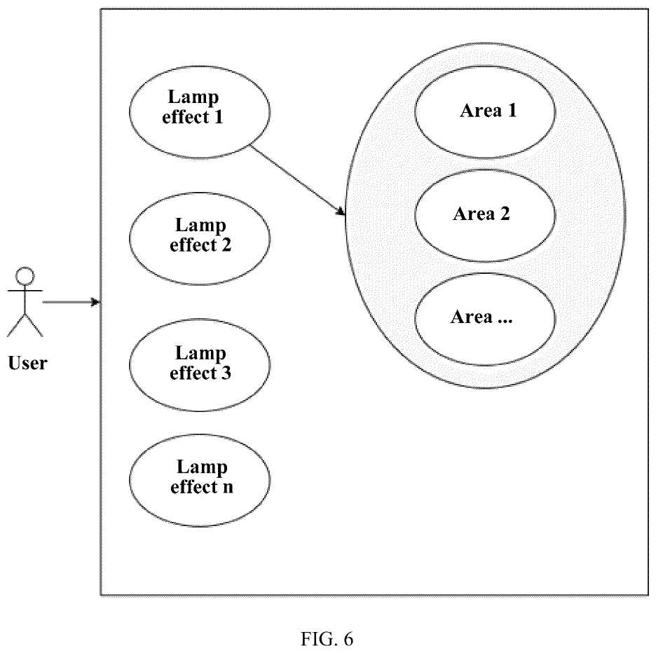

A relationship between a lamp effect and an area is shown in FIG. 6. An area can be interpreted as a set of point-controlled lamp beads. The user can divide different point-controlled lamp beads into different areas to achieve independent control of different areas. Optionally, after the setting is completed, the selected point-controlled lamp beads with corresponding serial numbers will light up.

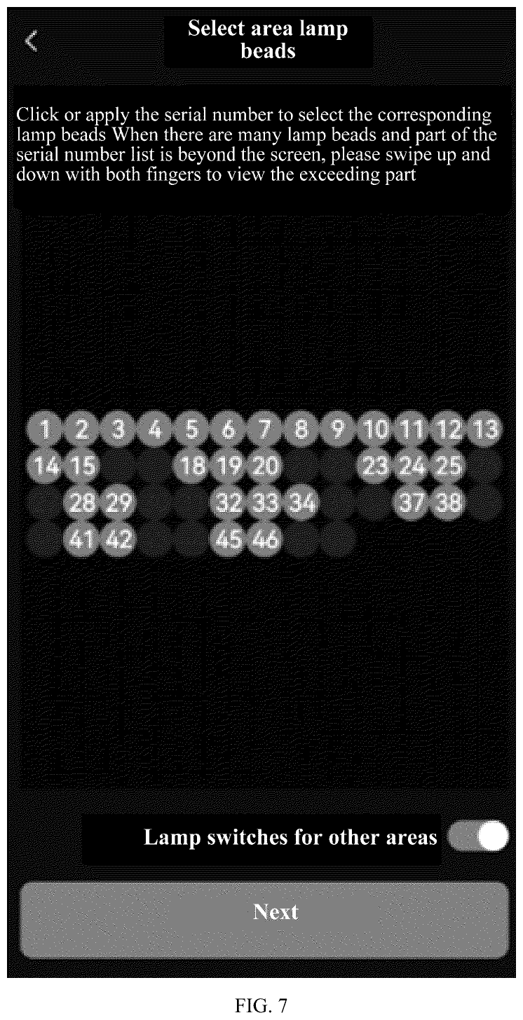

In an embodiment, an interface of dividing point-controlled lamp beads by areas through an area editing unit is shown in FIG. 7. When dividing the point-controlled lamp beads by areas through the area editing unit, the area editing unit includes a canvas, and each numbered point on the canvas represents a point-controlled lamp bead. Lamp switches for other areas are set through the area editing unit, and after turning on the lamp switches for other areas, the points on the canvas representing the occupied point-controlled lamp beads in other areas will light up. The canvas can show a layout of the string lamp.

Optionally, the canvas includes a magnifier and a moving tool, where the magnifier can be used to zoom in/out the canvas, and when the canvas scale exceeds 100%, the user can select the moving tool to move the canvas by holding down and dragging the canvas with his/her fingers.

In an embodiment, after dividing point-controlled lamp beads by areas through an area editing unit, the user can independently control a switch for the point-controlled lamp beads in the area, or control all the switches for all point-controlled lamp beads in the area with one click.

S204, editing an area lamp effect through a lamp effect editing unit, where the types of the area lamp effect include a single image, an animation and a preset, and selecting a type of area lamp effect for lamp effect editing; and

Optionally, when editing a lamp effect of the area through the lamp effect editing unit, the user can click “back” to automatically save the edited area lamp effect to prevent misoperation.

The lamp effect editing unit further includes a canvas and lamp switches for other areas. By operating the points representing point-controlled lamp beads on the canvas, the user can preview the lamp effect, and design the lamp effect more clearly by turning off the lamp switches for other areas. Optionally, the lamp effect of the string lamp can be changed in real time according to operation functions.

S205, saving the area lamp effect through the area creating unit, and after all the areas are created and saved, saving the lamp effects through the lamp effect creating unit to obtain a lamp effect scheme.

Specifically, after saving the designed area lamp effect through the area creating unit, the user can create a new area to continue the design. After designing and saving all required area lamp effects, the user can combine these area lamp effects through the lamp effect creating unit to form a complete lamp effect scheme.

In an embodiment, when it is applied to a lattice-shaped string lamp, the step of “obtaining a lamp effect scheme through control software design” further includes:

S301, creating a lamp effect through a lamp effect creating unit and setting the number of strings of point-controlled lamp beads of the string lamp and the total number of point-controlled lamp beads of a single string;

The lattice-shaped string lamp refers to a string lamp shaped like a curtain, a Christmas tree, or a waterfall, etc. The curtain lamp is composed of a plurality of vertically arranged lamp beads, which can be hung on a window, a wall, or any other surface to achieve a lamp effect of continuously lighting up or flashing from top to bottom; the Christmas tree string lamp is usually used to decorate a Christmas tree, and its lamp beads light up in different ways (such as flashing or gradually changing) to create a festive atmosphere; and the waterfall string lamp is designed to be in the shape of a waterfall and used to decorate an indoor or outdoor wall, a courtyard, etc.

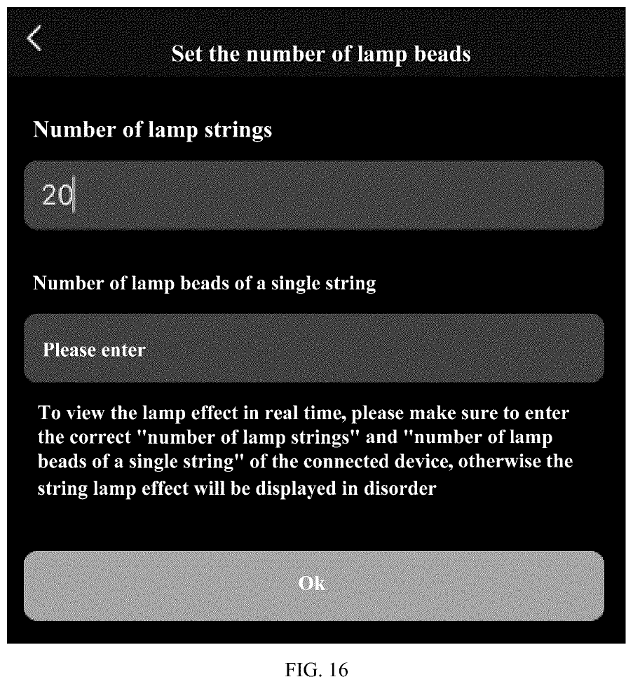

An interface of setting the number of strings of point-controlled lamp beads of the string lamp and the total number of point-controlled lamp beads of a single string is shown in FIG. 16.

S302, editing a lamp effect through a lamp effect editing unit, where the types of the lamp effect include a single image, an animation and a preset, and selecting a type of lamp effect for lamp effect editing; and

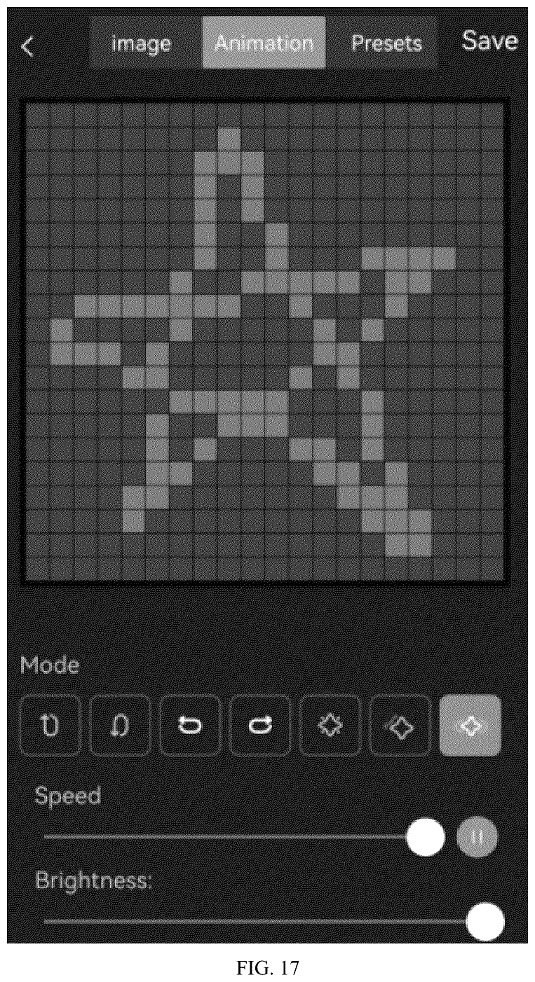

The lamp effect editing unit includes a rectangular canvas, each small grid in the rectangular canvas represents a point-controlled lamp bead, and an interface of the rectangular canvas is shown in FIG. 17.

S303, saving the lamp effects through the lamp effect creating unit to obtain a lamp effect scheme.

The functions of the lamp effect creating unit and the lamp effect editing unit are the same as those specified in S201 and S204, and will not be repeated here. It is worth noting that when the lamp effect control method is applied to a lattice-shaped string lamp, design of a lamp effect scheme through the steps of S201-S205 is poor in efficiency and not intuitive, so this embodiment is provided.

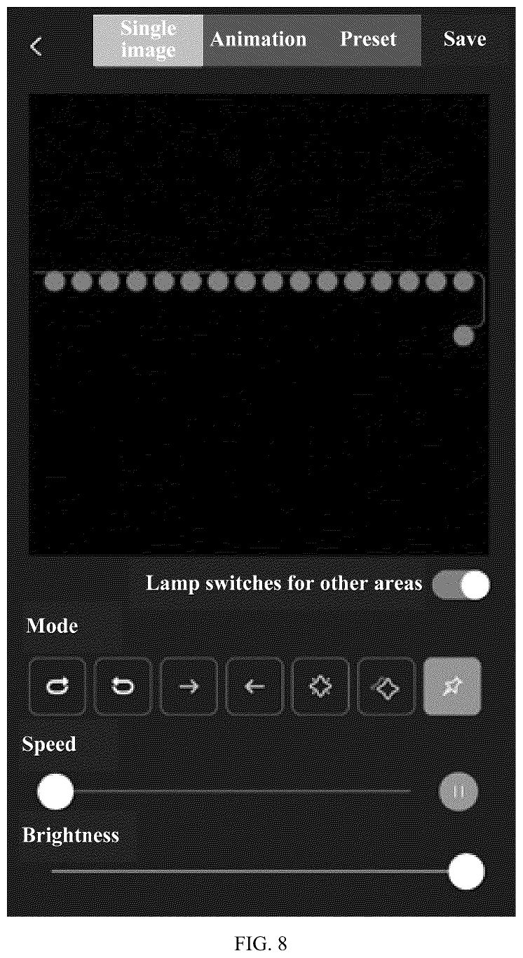

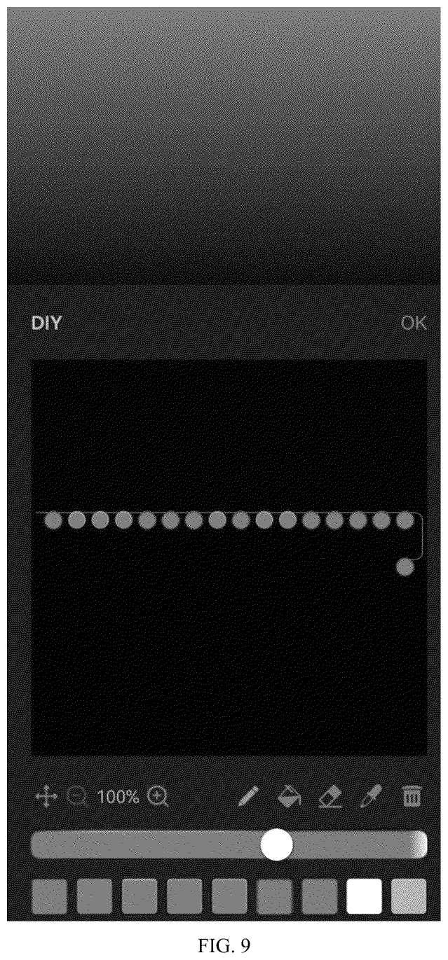

In an embodiment, when selecting a type of area lamp effect for lamp effect editing, an interface of editing a lamp effect of a single image type is shown in FIGS. 8 and 9. Design of a lamp effect scheme according to the lamp effect of a single image type specifically includes:

S401, selecting a dynamic effect of point-controlled lamp beads, and the dynamic effect includes forward movement, reverse movement, cyclic forward movement, cyclic reverse movement, breathing, flickering and being static;

The forward movement refers to a process of sequentially turning on and off point-controlled lamp beads from left to right (i.e. clockwise), which forms a continuous movement effect; the reverse movement refers to a process of sequentially turning on and off the point-controlled lamp beads from right to left (i.e. counterclockwise); the cyclic forward movement refers to a process of sequentially turning on and off the point-controlled lamp beads from left to right (i.e. clockwise), and cyclically repeating this process to form a smooth dynamic effect; the cyclic reverse movement refers to a process of sequentially turning on and off the point-controlled lamp beads from right to left (i.e. counterclockwise), and cyclically repeating the process; the breathing refers to a process of changing the point-controlled lamp beads from dark to bright and then from bright to dark, and cyclically repeating this process; the flashing refers to a process of rapidly flashing the point-controlled lamp beads and cyclically repeating this process; and the being static refers to a state of keeping the point-controlled lamp beads unchanged.

S402, selecting a change speed of point-controlled lamp beads through a change speed adjustment bar;

Specifically, adjustment of the change speed of the point-controlled lamp beads is achieved by setting a change speed adjustment bar. Through the change speed adjustment bar, the user can set a change speed capture point to obtain the change speed at the change speed capture point. The two ends of the change speed adjustment bar correspond to a zero change speed and a maximum change speed, respectively, where the zero change speed corresponds to the static state of point-controlled lamp beads, and the maximum change speed means that the point-controlled lamp beads change at the maximum change speed. Change speeds are gradient between the two ends of the change speed adjustment bar, and the point-controlled lamp beads change at the corresponding gradient change speeds.

S403, selecting the brightness of point-controlled lamp beads through a brightness adjustment bar; and

Specifically, adjustment of the brightness of the point-controlled lamp beads is achieved by setting a brightness adjustment bar. Through the brightness adjustment bar, the user can set a brightness capture point to obtain the brightness at the brightness capture point. The two ends of the brightness adjustment bar correspond to zero brightness and full brightness, respectively, where the zero brightness corresponds to the off state of point-controlled lamp beads, and the full brightness corresponds to the maximum brightness of the point-controlled lamp beads. Brightness is gradient between the two ends of the brightness adjustment bar, and the point-controlled lamp beads change at the corresponding gradient brightness.

S404, designing colors of point-controlled lamp beads through a first drawing board, where the first drawing board includes drawing tools and a color palette.

The drawing tools include a paintbrush tool, a paint bucket tool, an eraser tool, a straw tool, a trash can tool, etc.; the paintbrush tool is used for manual painting and coloring, and different paintbrush sizes can be selected for fine drawing according to needs; the paint bucket tool is used for one-click coloring, filling a selected area of point-controlled lamp beads with a specified color, coloring a whole area or filling a large area with a specified color; the eraser tool is used to erase the color of point-controlled lamp beads, and the size and shape of the eraser can be adjusted as needed to accurately erase the color of point-controlled lamp beads in a specified area; the straw tool is used to absorb a color from the canvas and then apply it to other point-controlled lamp beads, or select other existing colors for reuse; and the trash can tool is used to clear all colors on the canvas with one click, so as to restore the canvas to its initial state and facilitate redesign.

The color palette is composed of a plurality of gradient colors, each adjacent gradient color corresponds to a continuous color code, and the user can set a color capture point to obtain a corresponding color code at the color capture point. The color palette further includes several preset colors.

Optionally, in addition to use of a conventional color palette, the user can choose and create his/her favorite color combinations and save them in a personal color palette to facilitate reuse in different designs; the code of an current color can also be displayed for the user to control and adjust the color more accurately; the user not familiar with or skilled in color matching can be further provided with a color scheme generator, and can choose the dominant hue, secondary hues, etc. according to his/her needs or preferences. The system will automatically generate corresponding color schemes for reference and use. Optionally, the color palette can further include a gradient tool for creating smooth color transition effects.

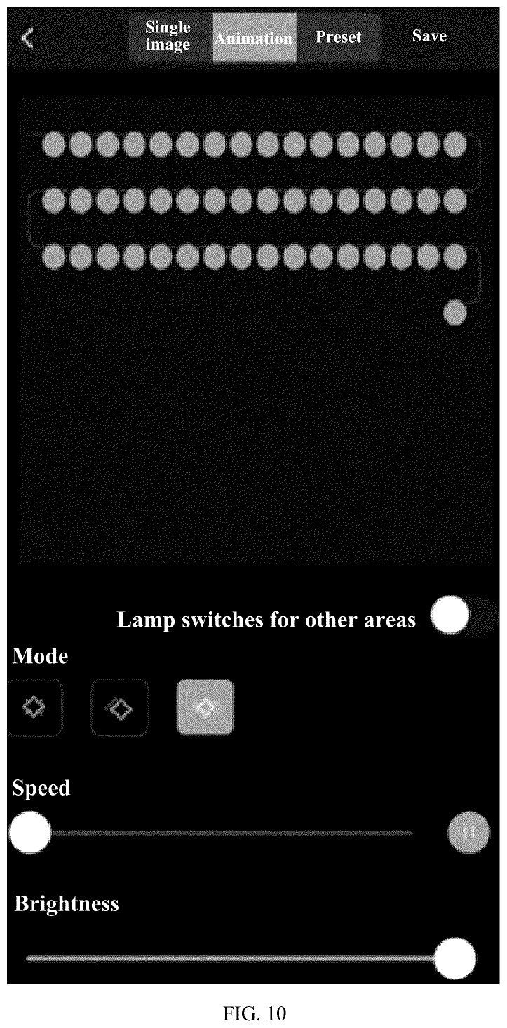

In an embodiment, when selecting a type of area lamp effect for lamp effect editing, an interface of editing a lamp effect of an animation area is shown in FIGS. 9 and 10. Design of a lamp effect scheme according to the lamp effect of the animation area specifically includes:

S501, selecting a dynamic effect of point-controlled lamp beads, and the dynamic effect includes flickering, breathing and jumping;

The flickering and the breathing are the same as those described in S301, and will not be repeated here. The jumping refers to the transition of point-controlled lamp beads from one color, brightness or mode to another, namely the change in the lamp effect. The jumping can be set to be sudden and obvious, or set to be fast and continuous.

S502, creating frames through a frame list;

A plurality of frames can be created according to needs, and the frames can be added, deleted, copied, switched, or previewed in the frame list. Each frame can record a moment when the brightness and color of point-controlled lamp beads are changed. Each frame can be designed, and the state of point-controlled lamp beads in each frame can also be defined through a series of computations or random algorithms, to ultimately form an animated effect.

S503, selecting a change speed of point-controlled lamp beads per frame through a change speed adjustment bar;

Specifically, after the frame number is determined, the change speed is set for each frame, that is, the duration of each frame is set. The function of the change speed adjustment bar is the same as that of the change speed adjustment bar in S302, and will not be repeated here.

S504, selecting the brightness of point-controlled lamp beads per frame through a brightness adjustment bar; and

S505, designing colors of point-controlled lamp beads per frame through a first drawing board, where the second drawing board includes drawing tools and a color palette, and lamp switches for other areas can be turned off to design the lamp effect more clearly.

Optionally, only keyframes can be designed, which are the most important frames of an animation and determine the effect of the animation. The keyframes refer to either each frame or selected several frames. The user can set the color and brightness of point-controlled lamp beads on the keyframes, and then add a transition effect between the keyframes to achieve smooth transition of the lamp effect between adjacent frames, so as to make the animation more fluent and natural. Common transition effects include gradient effect, fade-in fade-out effect, slow change effect, etc. The number of animation loops and repetitions can be set, for example, an infinite loop or a specific number of repetitions can be set.

The functions of the brightness adjustment bar and the second drawing board are the same as those of the brightness adjustment bar and the first drawing board in S303 and S304, and will not be repeated here.

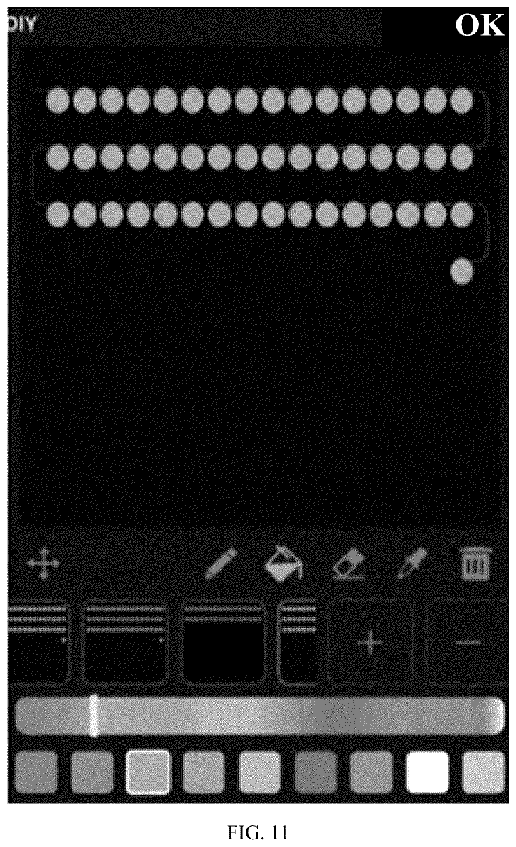

In an embodiment, when selecting a type of area lamp effect for lamp effect editing, an interface of editing a lamp effect of a preset area type is shown in FIG. 11. Design of a lamp effect scheme according to the lamp effect of a preset area type specifically includes:

S601, selecting by clicking on the lamp effect number, where the area lamp effects include various lamp effects preset through the control software;

Optionally, the preset plurality of lamp effects are increased with the update of the control software version.

S602, selecting a change speed of point-controlled lamp beads through a change speed adjustment bar; and

S603, selecting the brightness of point-controlled lamp beads through a brightness adjustment bar.

The functions of the change speed adjustment bar and the brightness adjustment bar are the same as those of the change speed adjustment bar and the brightness adjustment bar in S302 and S303, and will not be repeated here.

In an embodiment, the user can upload a designed lamp effect scheme online through control software for other users to download and use, with details specifically including:

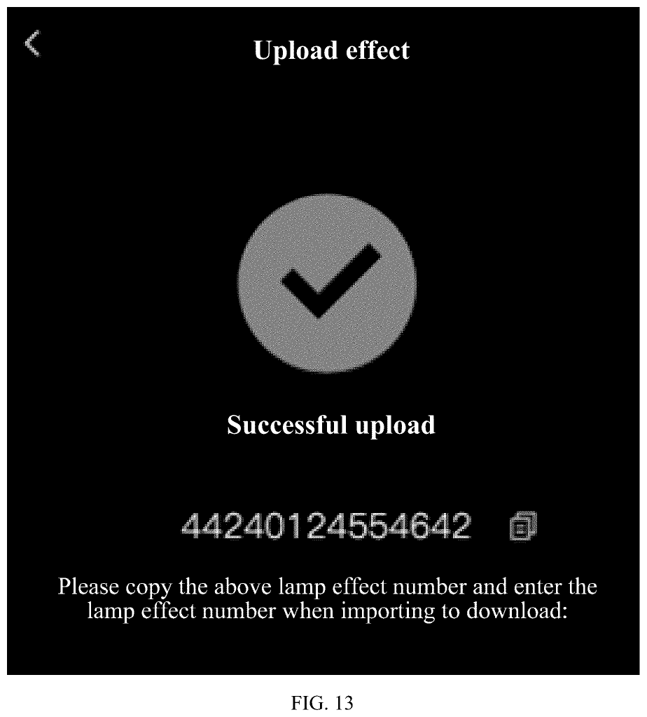

S701, the control software further includes a lamp effect sharing module, the user, through the lamp effect sharing module, uploads a lamp effect scheme created and saved on the control software online, and after uploading successfully, obtains the lamp effect number of the uploaded lamp effect scheme (as shown in FIG. 13), so that other users can download the lamp effect scheme according to the lamp effect number; and
the user can upload all the lamp effect schemes in the control software with just one click, or upload a selected lamp effect scheme to achieve selective sharing. The other user can be a user other than the user who uploads the lamp effect scheme, or the user who uploads the lamp effect scheme.

Optionally, the lamp effect scheme can be uploaded to a server through the control software, such as an Amazon cloud server.

S702, other users can download a corresponding lamp effect scheme by entering the lamp effect number in the control software; and

In addition to the lamp effect schemes stored in the network, lamp effect schemes stored in other storage media (such as local files) can also be received through the control software, so that the users can fully utilize and share lamp effect design resources.

S703, other users can reedit the lamp effect scheme to further improve or achieve other personalized demands; and

optionally, the lamp effect sharing module may include an interactive unit, the user can add his/her interpretations or share his/her insights when uploading the lamp effect scheme, and other users can score, comment on, and collect the uploaded lamp effect scheme, so that the users can better understand and use the uploaded lamp effect scheme; and by integrating other online resources, such as social networks and forums, more lamp effect design resources can be further shared, and the users can have access to relevant communities through the control software to facilitate the sharing and exchange of lamp effect resources among users.

In an embodiment, a string lamp of ornament series (i.e., a motor-driven product or a conventional non-point-controlled monochrome LEDs product) can be configured with I/O interfaces for detailed parameter settings.

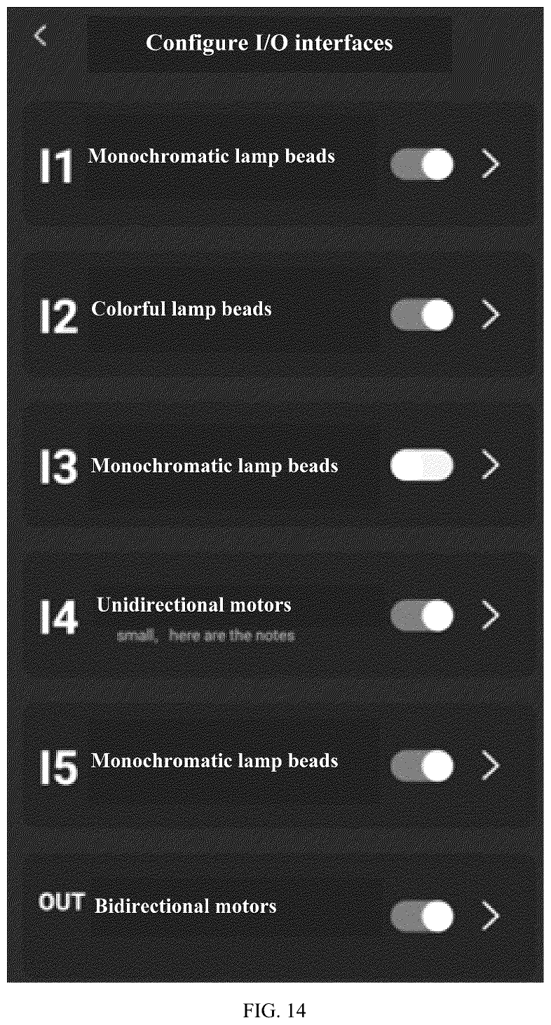

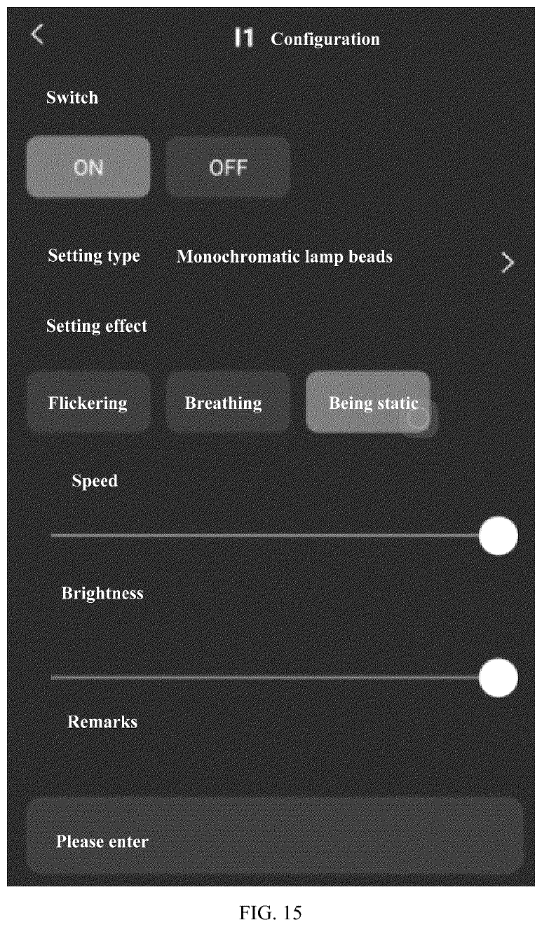

Specifically, the user clicks an “I/O” configuration option in an area creating unit to enter the I/O configuration page (as shown in FIG. 14). In the I/O configuration page, the user can click on an IO interface to enter a detailed parameter setting interface (as shown in FIG. 15). The detailed parameter setting interface includes the options of switches, setting types, setting effects, speeds, brightness and remarks. The setting types are set based on physical elements, including monochromatic point-controlled lamp beads, colorful point-controlled lamp beads, unidirectional motors, bidirectional motors, etc. Different parameters can be set for different types. The setting effects include flickering, breathing, being static and the like. The remarks are used for identifying and memorizing. After configuring all I/O interfaces, the user can return to the area creating unit.

In a second aspect, the present disclosure provides a lamp effect control device, and the device includes a control terminal, control software, controller firmware and a string lamp, where
the control software is installed and run on the control terminal, including a lamp effect editing module and a data processing module, where the lamp effect editing module is configured to design and obtain a lamp effect scheme and send the lamp effect scheme to the data processing module, and the data processing module is configured to convert the received lamp effect scheme into a control instruction and send the control instruction to the control terminal;
the control terminal includes a first communication module configured to receive the control instruction and send the control instruction to the controller firmware;
the controller firmware is in fit with the control terminal and the control software, including a second communication module, a control module and a drive module, where the second communication module is configured to receive the control instruction, the control module is configured to convert the control instruction into a control signal, and the drive module is configured to send the control signal to the string lamp; and
the string lamp is an addressable string lamp that is in fit with the controller firmware, and the string lamp includes a plurality of point-controlled lamp beads, receives the control signal, and implements the lamp effect scheme through the point-controlled lamp beads.

In a third aspect, the present disclosure provides an electronic apparatus, and the apparatus includes a processor and a memory, where a computer program is stored on the memory, and the processor is configured to implement the above lamp effect control method when executing the computer program.

Optionally, the computer program can be divided into one or more modules/units (such as a computer program 1, a computer program 2, etc.), and the one or more modules/units are stored in the memory and executed by the processor. The one or more modules/units can be a series of computer program instruction segments capable of achieving specific functions, and the instruction segments are configured to describe the process of executing the computer program in the computer device.

Optionally, the electronic apparatus may include one or more processors, the processor can be a central processing unit (CPU), a microprocessor unit (MPU), any other general-purpose processor, a digital signal processor (DSP), an application specific integrated circuit (ASIC), a field-programmable gate array (FPGA), or any other programmable logic device (PLD), a discrete gate or a transistor logic device, or a discrete hardware component, etc. The general-purpose processor can be a microprocessor, or the processor may also be any conventional processor. The processor is the control center of the computer device and connects various parts of the computer device through various interfaces and circuits.

Optionally, the electronic apparatus may include one or more memories, and the memory mainly includes a program storage area and a data storage area, where an operating system, at least one application program required for function realization, and the like are stored in the program storage area, and relevant data may be stored in the data storage area. Further, the memory can be a high-speed random access memory or a non-volatile memory, such as a plug-in hard drive, a smart media card (SMC), a secure digital (SD) card, a flash card, or any other volatile solid-state storage device. In some embodiments, the memory may further include a remote memory relative to the processor, and such remote memory can be connected to a computer terminal through the network. Examples of the above network include but are not limited to the Internet, enterprise intranet, local area networks (LANs), mobile communication networks and their combinations.

Optionally, the electronic apparatus is also capable to communicate with one or more external devices (such as keyboards, pointing devices, Bluetooth devices, etc.), one or more devices that enable users to interact with the electronic apparatus, and/or any device that enables the electronic apparatus to communicate with one or more other computing devices (such as routers, modems, etc.). Such communication can be performed through input/output (I/O) interfaces. Further, the electronic apparatus, through network adapters, is also capable to communicate with one or more networks (such as LANs, a wide area network (WAN), and/or public networks, such as the Internet). Other hardware and/or software modules can be used in combination with the electronic apparatus, including but not limited to microcodes, device drivers, redundant processing units, peripheral disk drive arrays, RAID systems, tape drives and data backup storage systems.

In a fourth aspect, the present disclosure provides a computer-readable storage medium, and the medium includes a stored computer program, where when the computer program is executed, the device where the computer-readable storage medium is located is controlled to implement the above lamp effect control method.

Optionally, the computer-readable storage medium may be, but is not limited to, a system, device or component of electricity, magnetism, light, electromagnetism, infrared or semiconductor, or any combination thereof. More specific examples of the computer-readable storage medium (a non-exhaustive list) include: an electrical connection with one or more wires, a portable disk, a hard drive, a random access memory (RAM), a read-only memory (ROM), an erasable programmable read-only memory (EPROM or flash), optical fibers, a portable compact disc read-only memory (CD-ROM), an optical storage device, a magnetic storage device, or any appropriate combination of the above.

Program codes for executing the operations of the present disclosure can be written in any combination of one or more programming languages, and the programming languages include object-oriented programming languages such as Java and C++, further including conventional programming languages such as C language or similar programming languages. The program codes can be executed only on the user's computing device, executed partially on the user's computing device, executed as an independent software package, executed partially on the user's computing device and partially on a remote computing device, or executed only on a remote computing device or server. In the case of involving a remote computing device, the remote computing device can be connected to the user's computing device through any network, including the LAN or WAN, or can be connected to a peripheral computing device (such as Internet connection through an Internet service provider).

The above are merely preferred embodiments of the present disclosure, and are not intended to limit the present disclosure. Those skilled in the art should be aware that many examples can be envisioned based on the basic methods and principles provided in the present disclosure according to actual situations, should fall within the scope of protection of the present disclosure without making sufficient creative efforts.

In the Specification of the present disclosure, it should be noted that orientation or position relationships indicted by the terms “central”, “longitudinal”, “transverse”, “length”, “width”, “thickness”, “upper”, “lower”, “front”, “rear”, “left”, “right”, “vertical”, “horizontal”, “top”, “bottom”, “interior”, “exterior” and the like are based on orientation or position relationships shown in the drawings, merely for the convenience of describing the present disclosure and simplifying the description, rather than indicating or implying that the indicated device or element must have particular orientations or be constructed and operated in particular orientations. Therefore, these terms should not be construed as a limitation to the present disclosure. Unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection or communication with each other; may be a direct connection, or an indirect connection via an intermediate medium; and may be communication inside two elements, or an interactive relation between two elements. For those of ordinary skill in the art, the specific meanings of the above terms in the present disclosure may be understood according to specific circumstances.

It is to be explained that in the Specification of the present disclosure, the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants are intended to cover the non-exclusive including, thereby making that the process, method, object or apparatus comprising a series of elements comprise not only those elements but also other elements that are not listed explicitly or the inherent elements to the process, method, merchandise or apparatus.

What is claimed is:

1. A lamp effect control method, comprising:
obtaining a lamp effect scheme through control software design, converting the lamp effect scheme into a control instruction, and sending the control instruction to a control terminal;
receiving the control instruction through the control terminal and sending the control instruction to controller firmware; and
receiving the control instruction through the controller firmware, converting the control instruction into a control signal, and sending the control signal to a string lamp; and
receiving the control signal through the string lamp and implementing the lamp effect scheme according to the control signal.

2. The lamp effect control method according to claim 1, wherein the step of “obtaining a lamp effect scheme through control software design” further comprises:
creating a lamp effect through a lamp effect creating unit and setting the total number of point-controlled lamp beads of the string lamp;
creating an area through an area creating unit;
dividing the point-controlled lamp beads of the string lamp by areas through an area editing unit;
editing an area lamp effect through a lamp effect editing unit, wherein the types of the area lamp effect comprise a single image, an animation and a preset, and selecting a type of area lamp effect for lamp effect editing; and
saving the area lamp effect through the area creating unit, and after all the areas are created and saved, saving the lamp effects through the lamp effect creating unit to obtain a lamp effect scheme.

3. The lamp effect control method according to claim 2, wherein when it is applied to a lattice-shaped string lamp, the step of “obtaining a lamp effect scheme through control software design” further comprises:
creating a lamp effect through a lamp effect creating unit and setting the number of strings of point-controlled lamp beads of the string lamp and the total number of point-controlled lamp beads of a single string;
editing a lamp effect through a lamp effect editing unit, wherein the types of the lamp effect comprise a single image, an animation and a preset, and selecting a type of lamp effect for lamp effect editing; and
saving the lamp effects through the lamp effect creating unit to obtain a lamp effect scheme.

4. The lamp effect control method according to claim 1, wherein the control software comprises a lamp effect sharing module, and through the lamp effect sharing module, the obtained lamp effect scheme is uploaded online for other users of the control software to download and use.

5. The lamp effect control method according to claim 2, wherein after selecting a single image according to the step of selecting a type of area lamp effect for lamp effect editing, the following area lamp effects are available, comprising forward movement, reverse movement, cyclic forward movement, cyclic reverse movement, breathing, flickering and being static, further comprising the change speed, brightness and color.

6. The lamp effect control method according to claim 2, wherein after selecting an animation according to the step of selecting a type of area lamp effect for lamp effect editing, the following area lamp effects are available, comprising flickering, breathing and jumping, further comprising frame creating, wherein each frame created through the frame creating comprises information of the change speed, brightness and color.

7. The lamp effect control method according to claim 2, wherein after selecting a preset according to the step of selecting a type of area lamp effect for lamp effect editing, the following area lamp effects are available, comprising various lamp effects preset through the control software, which can be selected by clicking on the lamp effect number, further comprising the change speed and brightness.

8. A lamp effect control device, comprising a control terminal, control software, controller firmware and a string lamp, wherein
the control software is installed and run on the control terminal, comprising a lamp effect editing module and a data processing module, wherein the lamp effect editing module is configured to design and obtain a lamp effect scheme and send the lamp effect scheme to the data processing module, and the data processing module is configured to convert the received lamp effect scheme into a control instruction and send the control instruction to the control terminal;
the control terminal comprises a first communication module configured to receive the control instruction and send the control instruction to the controller firmware;
the controller firmware is in fit with the control terminal and the control software, comprising a second communication module, a control module and a drive module, wherein the second communication module is configured to receive the control instruction, the control module is configured to convert the control instruction into a control signal, and the drive module is configured to send the control signal to the string lamp; and
the string lamp is an addressable string lamp that is in fit with the controller firmware, and the string lamp comprises a plurality of point-controlled lamp beads, receives the control signal, and implements the lamp effect scheme through the point-controlled lamp beads.

9. An electronic apparatus, comprising a processor and a memory, wherein a computer program is stored on the memory, and the processor is configured to implement the above method according to claim 1 when executing the computer program.

10. A computer-readable storage medium, comprising a stored computer program, wherein when the computer program is executed, the device wherein the computer-readable storage medium is located is controlled to implement the above method according to claim 1.
